(19) United States
(12) Patent Application Publication
(10) Pub. No.: US 2003/0169546 A1
(43) Pub. Date: Sep. 11, 2003

(54) Circuit for the protection and supply of consuming circuits

(76) Inventors: Stig Lindemann, Aarhus (DK); Gade Knud Nielsen, Viborg (DK)

Correspondence Address: PITNEY, HARDIN, KIPP & SZUCH LLP, 685 THIRD AVENUE, NEW YORK, NY, 10017-4024, US

(21) Appl. No.: 10/258,727

(22) PCT Filed: Apr. 26, 2001
(86) PCT No.: PCT/DK01/00280

(30) Foreign Application Priority Data
Apr. 27, 2000 (DK) PA 2000 00750

(51) Int. Cl. H02H 9/00

(52) U.S. Cl. 361/57

(57) ABSTRACT

The invention relates to an electronic circuit for supplying and protecting another consuming circuit against undesirably high electrical values. The supply circuit is formed with at least 2 independent monitoring circuits performing independent measurement of an error state on the basis of a common threshold value generated from a value determined in the circuit. Recording of an error state in a monitoring circuit results in activation of at least one independent current path between the supply potential of the supply circuit and an associated reference value. This ensures that the electrical circuit increases the current through a separator circuit, which, after activation, isolates the consuming circuit from the remaining circuit. Also, the same reference value may be used for several monitoring circuits whereby tolerance deviations for components may be compensated so that a supply voltage and a safety voltage have values with a small difference.

The invention relates to an electronic monitoring circuit for supplying and monitoring a consuming electrical circuit, wherein the supply circuit contains means for interrupting and isolating the consuming circuit, wherein the supply circuit contains at least two redundant monitoring circuits which contain electronic switches, wherein the switches are activated by the monitoring circuit if a limit value is exceeded, wherein the switches, when activated, form a current path between the current source of the supply circuit and an associated reference value.

A circuit of this type is known from U.S. Pat. No. 4,858,054, which describes an electrical protective circuit for fire protection of a consuming electrical apparatus if an electrical short-circuit occurs. The protective circuit consists of three thyristors which each form a current path that, upon opening of one of the thyristors, causes a great increase in the current through a fuse which is thereby broken, which causes, the circuit to be interrupted. The gate terminals of the thyristors are connected to the supply voltage through resistors.

However, the thyristors will have varying electrical properties, and their activation voltage may be different. Thereby, only one thyristor will be activated, while the other thyristors are hardly activated. Because the thyristors have an activation voltage that differs from component to component, a relative voltage difference between a supply voltage to a consuming apparatus and a safety voltage for the apparatus will necessarily have a size that prevents premature activation. Therefore, supply voltage and activation voltage will have to be determined with a relatively great difference. If there is a great physical distance between the protective circuit and the consuming apparatus, a power supply will have a poor efficiency if there must be a great voltage difference between supply voltage and safety voltage.

The object of the invention is to provide a supply voltage for monitoring and supplying a consuming circuit, wherein a voltage difference between a supply voltage and a safety voltage is minimized, thereby reducing the energy loss of the supply circuit.

This can be achieved with a circuit like the one described in the opening paragraph, if the supply circuit determines a limit value for at least one electrical parameter on the basis of a threshold value, wherein the threshold value is determined by a common reference circuit, wherein the common threshold value forms a reference for at least the redundant monitoring circuits, wherein the monitoring circuits monitor at least one electrical parameter on the basis of the common threshold value.

Hereby it may be ensured that the electrical circuit increases the current through a separator circuit which, after activation, isolates the consuming circuit from the remaining circuit. It may likewise be ensured that the same reference value is used for several monitoring circuits, whereby tolerance deviation for components may be compensated so that a supply voltage and a safety voltage have values with a small difference. With a small difference between supply and safety voltages the circuit may be activated quickly at an observed deviation, and with an effective control of the monitoring circuits the circuit can operate with the small difference without any risk of premature activation. Further, great reliability of the monitoring circuit may be achieved with a redundant structure.

The common threshold value may also be used as a reference for controlling the electronic supply circuit. Hereby, common adjustment of both supply voltage and safety voltage may be achieved. It is ensured at the same time that the voltages will partially follow each other if the threshold value is affected.

The current paths may be formed by semiconductor components which may be connected to their own monitoring circuit, wherein the conductivity of the semiconductor components is controlled by input terminals which are connected to associated monitoring circuits that are controlled on the basis of the threshold value. It may be ensured hereby that the tolerances of the semiconductor components have a limited influence on the actual safety voltage.

The threshold value may advantageously be formed on the basis of the selected size of a resistor. Since a resistor can be a very stable and reliable component, a safe and stable threshold value can be achieved hereby.

The threshold value may instead be formed from a programmable component which determines the desired threshold value on the basis of a programming. The threshold value may hereby be changed in a simple manner. The individual circuit may be adjusted to the exact value by a program change.

The current paths of the circuit may be composed of thyristors, with gate terminals which are connected to voltage monitoring circuits which are controlled on the basis of the common threshold value. The rate of the thyristors may hereby be used to advantage, said monitoring circuits providing a small difference between supply voltage and safety voltage.

The electronic circuit may control and monitor a multi-phase AC supply of an electrical consuming apparatus. All phases may be monitored by their respective circuits, where triacs, upon activation, form a short-circuit between the phases, whereby fuses in the supply voltage are broken.

The electronic circuit can instead supply and monitor a DC supply of an electrical consuming apparatus arranged in a potentially explosive environment. Hereby, the supply voltage to a circuit arranged in a potentially explosive environment may be interrupted before a voltage has been built up that may cause sparking which can trigger an explosion.

The DC supply voltage may be formed by a switch mode controlled circuit which is controlled on the basis of the threshold value. The DC supply can hereby control a great current with great precision without a significant loss of power. The use of a common threshold value results in a simple adjustment of supply voltage and safety voltage.

Also, an AC supply circuit may be formed by a switch mode controlled circuit in the form of a well-known frequency converter which may be controlled on the basis of the threshold value. Hereby an AC supply may likewise be controlled on the basis of the threshold value. Electrical circuits supplying electronics in e.g. potentially explosive environments are usually connected in front of a suitable safety fuse. In connection with overvoltage, and thereby risk of sparking, however, it is not expected that the fuse blows sufficiently quickly to avoid ignition. To accelerate fuse blowing, it is proposed to detect overvoltage with an electronic circuit and to activate an electronic switch to rapidly increase the current through the fuse, thereby causing the fuse to blow sufficiently quickly to avoid sparking.

The invention will be explained more fully below with reference to the accompanying drawing, in which:

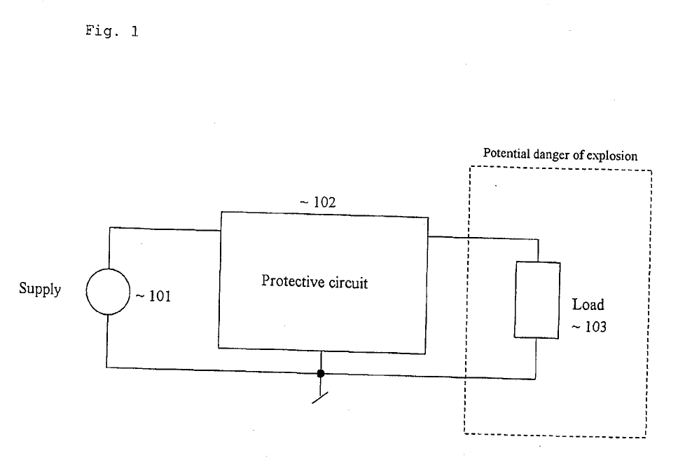

FIG. 1 shows a block diagram of an electronic circuit (102) for supplying, monitoring and protecting another consuming circuit (103) against undesirably high electrical values. Supply of the electronic circuit (102) takes place from the supply (101). The load (103) may be present in a potentially explosive environment with a great distance to the supply circuit.

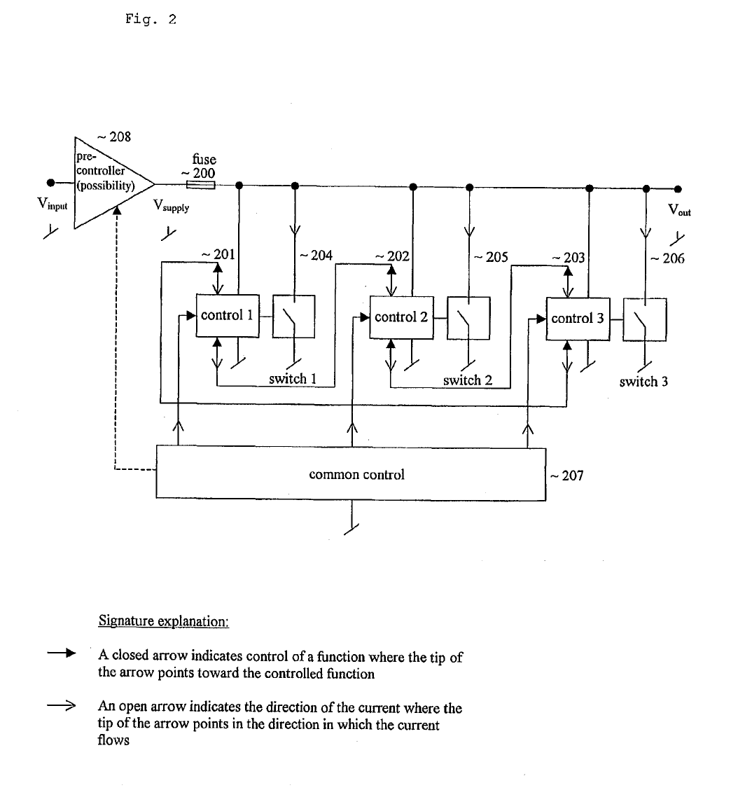

FIG. 2 shows an example of a detailed block diagram of the electronic circuit for supplying and protecting another consuming circuit against undesired electrical values. The supply circuit contains a separator circuit 200 connected to a current source 208. The supply circuit also contains several protective circuits which contain several voltage monitoring circuits with means for activating an electronic switch that increases the current through the separator circuit to earth. The separator circuit may consist of a series-connected fuse that blows. The increased current through the series-connected fuse (200) causes the series-connected fuse to blow quickly, thereby providing a higher degree of safety in the other consuming circuit that may be arranged in a potentially explosive environment. However, the protective circuit may be composed of a plurality of components which, upon activation, provide an electrical separation. In the example shown in FIG. 2, the protective circuit is tripled (201), (202) and (203), and correspondingly the electronic switch is tripled (204), (205) and (206). This provides a higher degree of circuit reliability. A threshold value of the permitted electrical maximum value is determined by the common reference circuit (207). A threshold value is taken to mean a reference value which forms the basis for determining whether a measured value has a permitted or non-permitted size. A circuit (208), which is controlled by feedback from the reference circuit (207), may e.g. be used to control the permitted electrical maximum value within determined limits.

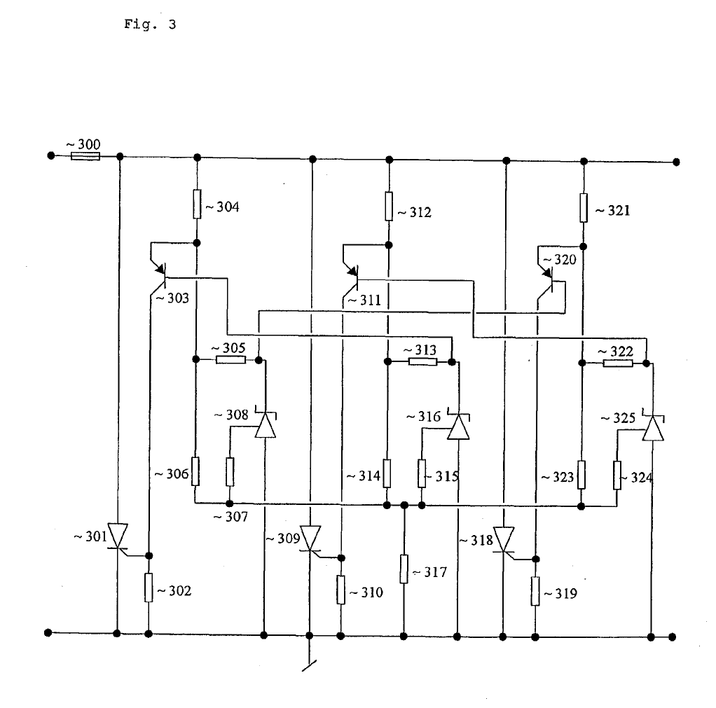

FIG. 3 shows a possible embodiment of the electronic circuit for supplying and protecting another consuming circuit against undesirably high electrical values. A separator circuit shown as a fuse (300) connects a current source (not shown) to the consuming circuit. The fuse (300) is moreover connected to the anode on the thyristors (301, (309) and (318) as well as to the resistors (304), (312) and (321). The cathode of the thyristors (301), (309) and (318) is connected to earth. Control input on the thyristor (301) is connected to the resistor (302) and the collector of the transistor (303). The resistor (302) is moreover connected to earth. Control input on the thyristor (309) is connected to the resistor (310) and the collector of the transistor (311). The resistor (310) is moreover connected to earth. Control input on the thyristor (318) is connected to the resistor (319) and the collector of the transistor (320). The resistor (319) is moreover connected to earth. The emitter of the transistor (303) is connected to the resistor (304), (305) and (306). The base of the transistor (303) is connected to the resistor (313) and the cathode of the voltage controller (316). The anode of the voltage controller (316) is connected to earth. Control input on the voltage controller (316) is connected to the resistor (315). The emitter of the transistor (311) is connected to the resistor (312), (313) and (314). The base of the transistor (311) is connected to the resistor (322) and the cathode of the voltage controller (325). The anode of the voltage controller (325) is connected to earth. Control input on the voltage controller (325) is connected to the resistor (324). The emitter on the transistor (320) is connected to the resistor (321), (322) and (323). The base of the transistor (320) is connected to the resistor (305) and the cathode of the voltage controller (308). The anode of the voltage controller (308) is connected to earth. Control input on the voltage controller (308) is connected to the resistor (307). The resistor (306), (307), (315), (323) and (324) is connected to the resistor (317). The resistor (317) is connected to earth.

The circuit shown in FIG. 3 operates in a normal operational situation in that a current runs through the separator circuit, fuse (300). In this situation the voltage is within the voltage range where the circuit is passive.

Here all the thyristors (301, 309 and 318) are in a blocked state. Moreover, the cathode voltage of the voltage controllers (308, 316 and 325) is of such a size that the base current on the transistors (303, 311 and 320) is so small that the transistors are in a blocked state. However, a current runs through the resistors (304, 312 and 321) further through the resistor (306, 314 and 323) to a branching point from which the total current runs further on through the resistor (317). This provides an approximately common reference value for the voltage controllers (308, 316 and 325). This means that it is possible to adjust the voltage at which it is desired to activate the circuit by changing the resistance value of the resistor (317).

In a state outside normal operation where the voltage of the circuit exceeds the set limit value, the current through the voltage controllers (308, 316 and 325) is increased. As a result, the base current of the transistors (303, 311 and 320) increases. Hereby, at least one of the voltage controllers (308, 316 and 325) will draw so much current that the associated transistor (303, 316 and 320) begins to conduct. It is assumed that it is the transistor (320) which conducts as the first one. The collector of the transistor (320) is connected to the gate terminal of the thyristor (318) which is thereby caused to assume a conduct state. This considerably increases the current through the thyristor (318) so that the fuse (300) blows with great certainty. As the circuit is triple, this means that if one of the circuits does not operate for some reason—it may be one of the thyristors (301, 309 and 318) or one of the voltage controllers (308, 316 and 325)—one of the other thyristors (301 or 309) will draw very quickly. This provides a very failsafe system as the safety circuit as such is triple.

The reliability of the circuit has hereby been increased quite considerably. There is just a single critical common component—viz. the resistor (317). This resistor may be selected as a special component with an extremely high reliability. Hereby, the reliability of the overall circuit will be very near a factor three better than a protective circuit having just a single branch.

1. An electronic monitoring circuit (102) to be connected between a supply circuit (101) and a consuming electrical circuit (103) for monitoring said consuming electrical circuit (103), wherein the electronic monitoring circuit (102) contains means for interrupting and isolating the consuming electrical circuit (103) from the supply circuit (101), wherein the electronic monitoring circuit (102) contains at least two redundant monitoring sub circuits (201, 202, 203) each connected to an associated electronic switch for interrupting and isolating the consuming electrical circuit (103) from the supply circuit (101), wherein the switches are activated if an electrical supply exceed a threshold value characterized in that the electronic monitoring circuit (102) determines said threshold value by a common reference circuit (207), defining a common threshold value for the at least two redundant monitoring sub circuits (201, 202, 203).

2. An electrical monitoring circuit according to claim 1, characterized in that when a switch connected to said monitoring sub circuit are activated, a current through a fuse (200) is increased.

3. An electronic monitoring circuit according to one of claim 1 or 2, characterized in that the common threshold value is also used as a reference for controlling the supply circuit.

4. An electronic monitoring circuit according to one of claims 1-3, characterized in that the switches are formed by semiconductor components, wherein the conductivity of the semiconductor components is controlled by input terminals which are connected to associated monitoring sub circuits that are controlled on the basis of the threshold value.

5. An electronic monitoring circuit according to one of claims 1-4, characterized in that the threshold value is formed on the basis of the selected size of a resistor (310).

6. An electronic monitoring circuit according to one of claims 1-5, characterized in that the threshold value is formed on the basis of a programmable component which determines the desired threshold value on the basis of a programming.

7. An electronic monitoring circuit according to one of claims 1-5, characterized in that the switches are formed by thyristors (308, 316, 325) with gate terminals connected to said monitoring sub circuits being voltage monitoring circuits which are controlled on the basis of the common threshold value.

8. An electronic monitoring circuit according to one of claims 1-7, characterized in that the electronic monitoring circuit monitors a multi-phase AC supply supplying a consuming electrical circuit.

9. An electronic monitoring circuit according to one of claims 1-8, characterized in that the electronic monitoring circuit monitors a DC supply, supplying an consuming electrical circuit arranged in a potentially explosive environment.

10. An electronic monitoring circuit according to one of claims 1-9, characterized in that the supply circuit is formed by a switch mode controlled circuit which is controlled on the basis of the threshold value.
